(19) United States
(12) Patent Application Publication
(10) Pub. No.: US 2025/0145823 A1
(43) Pub. Date: May 8, 2025

(54) FOAM-FORMING COMPOSITIONS CONTAINING A METAL CARBOXYLATE CATALYST, RELATED FOAMS AND METHODS FOR THEIR PRODUCTION

(71) Applicant: Covestro LLC, Pittsburgh, PA (US)

(72) Inventor: Brandon W. Parks, McKees Rocks, PA (US)

(21) Appl. No.: 18/500,709

(22) Filed: Nov. 2, 2023

(51) Int. Cl. C08L 75/04; C08K 5/01; C08K 5/07; C08K 5/098; C08K 5/17

(52) U.S. Cl. CPC C08L 75/04; C08K 5/01; C08K 5/07; C08K 5/098; C08K 5/17; C08L 2203/14

(57) ABSTRACT

Polyurethane foam-forming compositions, methods of producing polyurethane foams, polyurethane foams produced from such compositions made by such methods, as well as isocyanate-reactive compositions. The polyurethane foam-forming compositions include (a) a polyol, (b) catalyst composition comprising a tertiary amine and a metal carboxylate, (c) a blowing agent composition comprising a physical blowing agent and water, (d) a β-dicarbonyl compound, and (e) a polyisocyanate.

### FIELD

This specification pertains generally to polyurethane foam-forming compositions that include (a) a polyol, (b) catalyst composition comprising a tertiary amine and a metal carboxylate, (c) a blowing agent composition comprising a physical blowing agent and water, (d) a β-dicarbonyl compound, and (e) a polyisocyanate. This specification also relates to methods for producing polyurethane foams using such polyurethane foam-forming compositions and polyurethane foams produced from such foam-forming compositions.

### BACKGROUND

Rigid polyurethane foams are used in numerous applications. They are produced by reacting a polyisocyanate and an isocyanate-reactive compound, usually a polyol, in the presence of a blowing agent. One use of such foams is as a thermal insulation medium in the construction of refrigerated storage devices, including refrigerated appliances and tractor trailers.

There are several physical properties that are important for such foams. Specifically, in addition to exhibiting good thermal insulation properties (as determined by K-factor measurements), the foams must also be dimensionally stable and exhibit good compressive strength. To achieve this, the flow profile of the foam-forming composition should be optimized in order to minimize cell stretching. Cell stretching is often the result of unbalanced cure and flow profiles that causes the foam-forming composition to begin to gel, i.e., build viscosity, prior to the end of the flow (rise time) of the foam-forming composition. Foam formulators often achieve optimized flow profile by careful selection of specific catalyst packages that often include a combination of blow catalyst (catalysts that accelerate the isocyanate-water reaction) and gel catalysts (catalyst that accelerate the isocyanate-polyol reaction). A drawback to this solution, however, is that it can severely limit the foam-formulator's flexibility in terms of catalyst selection and amounts.

As a result, it would be desirable to provide means to easily tune and optimize the flow profiles of insulating rigid polyurethane foam formulations, thereby providing a foam formulator with greater formulating flexibility.

### SUMMARY

In certain respects, this specification relates to polyurethane foam-forming compositions. These polyurethane foam-forming compositions comprise a polyol, a catalyst composition, a blowing agent composition, a β-dicarbonyl compound, and a polyisocyanate. The catalyst composition comprises a tertiary amine and a metal carboxylate having the structure:

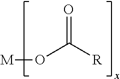

in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium. The blowing agent composition comprises a physical blowing agent and water. The β-dicarbonyl compound has the structure:

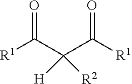

in which: (i) each R¹. which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹.

In other respects, this specification relates to methods of producing a polyurethane foam. The methods comprise reacting, at an isocyanate index of 0.90 to 1.50, a polyurethane foam-forming composition comprising a polyol, a polyisocyanate, a catalyst composition, a blowing agent composition, and a β-dicarbonyl compound. The catalyst composition comprises a tertiary amine and a metal carboxylate having the structure:

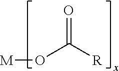

in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium. The blowing agent composition comprises a physical blowing agent and water. The β-dicarbonyl compound has the structure:

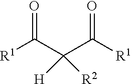

in which: (i) each R1, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹.

In yet other respects, this specification relates to isocyanate-reactive compositions. These isocyanate-reactive compositions comprise a polyol, a catalyst composition, a blowing agent composition, and a β-dicarbonyl compound. The catalyst composition comprises a tertiary amine and a metal carboxylate having the structure:

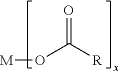

in which each R, which may be the same or different, is a saturated or unsaturated, and optionally substituted, (cyclo)alkyl group having 1 to 20 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium. The blowing agent composition comprises a physical blowing agent and water. The β-dicarbonyl compound has the structure:

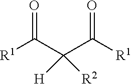

in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹.

This specification is also directed to rigid polyurethane foams produced from such foam-forming compositions and by such methods, as well as to composite articles comprising such rigid foams and panel insulation that includes such rigid foams.

### BRIEF DESCRIPTION OF THE DRAWINGS

FIGS. 1(a)-1(d) are graphs of the rise rate profiles of Example foams.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a β-dicarbonyl compound” means one or more β-dicarbonyl compounds, and thus, possibly, more than one β-dicarbonyl compound is contemplated and may be employed or used. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described and, in the case of the polyether polyols described in this specification, is calculated by the functionality of the starting compounds employed to produce the polyether polyol. In the production of polyurethane foams, the hydroxyl groups react with isocyanate groups, —NCO, which are attached to the isocyanate compound. The term “hydroxyl number” refers to the number of reactive hydroxyl groups available for reaction and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group and may be calculated by dividing the molecular weight of the polyol by its functionality. The equivalent weight of a polyol may also be calculated by dividing 56,100 by the hydroxyl number of the polyol—Equivalent Weight (g/eq)=(56.1×1000)/OH number.

As indicated, certain implementations of the present specification relate to polyurethane foam-forming compositions useful in the production of rigid foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers, 1964, page 239.

The polyurethane foam-forming composition of this specification include a polyisocyanate. As used herein, the term “polyisocyanate” encompasses diisocyanates, as well as polyisocyanates of greater functionality than 2.0.

Any of the known organic isocyanates, modified isocyanates or isocyanate-terminated prepolymers made from any of the known organic isocyanates may be used. Suitable organic isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclo-hexane diisocyanate, isomers of hexahydro-toluene diisocyanate, isophorone diisocyanate, dicyclo-hexylmethane diisocyanates, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenyl-polyisocyanates.

Undistilled or crude polyisocyanates may also be used. The crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified isocyanates are obtained by chemical reaction of diisocyanates and/or polyisocyanates. Useful modified isocyanates include, but are not limited to, those containing ester groups, urea groups, biuret groups, allophanate groups, carbodiimide groups, isocyanurate groups, uretdione groups urethane groups, or a combination of any two or more thereof. Examples of modified isocyanates include prepolymers containing NCO groups and having an NCO content of 25 to 35 weight percent, such as 29 to 34 weight percent, such as those based on polyether polyols or polyester polyols and diphenylmethane diisocyanate.

In certain implementations, the polyisocyanate comprises a methylene-bridged polyphenyl polyisocyanate and/or a prepolymer of methylene-bridged polyphenyl polyisocyanates having an average functionality of 1.8 to 3.5, such as 2.0 to 3.1, isocyanate moieties per molecule and an NCO content of 25 to 32 weight percent.

The polyurethane foam-forming compositions of this specification comprise a polyol, such as a polyether polyol. In some embodiments, the polyol comprises a blend of two or more different polyether polyols. Suitable polyether polyols include, without limitation, those prepared by addition of alkylene oxides onto starter compounds having isocyanate-reactive hydrogen atoms, often in the presence of a catalyst, such as a base catalyst or a double metal cyanide (DMC) compound. These starter compounds often have functionalities of 2 to 8, such as 2 to 6, or 2 to 4, and, in some implementations, are amine functional and/or hydroxyl functional. Specific examples of suitable starter compounds include (i) polyhydroxy compounds, such as water, ethylene glycol, 1,2-propanediol, 1,3-propanediol, diethylene glycol, trimethylolpropane, glycerol, trimethylolpropane, pentaerythritol, sorbitol, sucrose, and combinations of any two or more thereof, (ii) organic dicarboxylic acids, such as succinic acid, adipic acid, phthalic acid, terephthalic acid, and combinations of any two or more thereof, (iii) amines, such as ethylenediamine, diethylenetriamine, triethylenetetramine, propylenediamine, butylenediamine, hexamethylenediamine, toluene diamine, and combinations of any two or more thereof, and (iv) combinations of any two or more of the starters listed in (i)-(iii). Suitable alkylene oxides include, for example, ethylene oxide, 1,2-propylene oxide, 1,2-butylene oxide, 2,3-butylene oxide, styrene oxide, and combinations of any two or more thereof. In some implementations, propylene oxide and ethylene oxide are introduced into the reaction mixture singly, in admixture or in succession. When the alkylene oxides are added in succession, the products obtained contain polyether chains having block structures.

In some implementations, the polyol blend comprises an aromatic amine-initiated polyether polyol. As used herein, “aromatic amine-initiated polyether polyol” refers to a polyether polyol that is the reaction product of an H-functional starter comprising an aromatic amine, such as toluenediamine (“TDA”), with an alkylene oxide.

In certain implementations, the aromatic amine employed has an amine functionality of at least 1, such as 1 to 3 or 1 to 2. Specific examples of suitable aromatic amines which can be used include crude TDA obtained by the nitration of toluene followed by reduction; 2,3-TDA, 3,4-TDA, 2,4-TDA, 2,6-TDA or mixtures thereof; aniline; 4,4′-methylene dianiline; methylene-bridged polyphenyl polyamines composed of isomers of methylene dianilines and triamines or polyamines of higher molecular weight prepared by reacting aniline with formaldehyde by methods known in the art. In some implementations, a mixture composed of 2,3-TDA and 3,4-TDA (commonly referred to as “o-TDA”) is used.

In addition to the aromatic amine, other H-functional starters may also be used to prepare the aromatic amine-initiated polyether polyol. These other H-functional starters include, for example, water, propylene glycol, glycerin, ethylene glycol, ethanol amines, diethylene glycol, or a mixture of any two or more thereof. As will be appreciated, it is possible to use a wide variety of individual starters in combination with one another. In some implementations, however, aromatic amine is the predominant or essentially sole H-functional starter used to produce the aromatic amine-initiated polyether polyol. This means that, in these implementations, aromatic amine is present in an amount of more than 50% by weight, such as at least 80% by weight, at least 90% by weight, or even 100% by weight, based on the total weight of H-functional starter used to produce the aromatic amine-initiated polyether polyol.

A variety of alkylene oxides may be used to produce the aromatic amine-initiated polyether polyol, such as ethylene oxide, propylene oxide, butylene oxide, amylene oxide and mixtures thereof. The alkylene oxides may be added individually, sequentially one after the other to form blocks or in a mixture to form a heteric polyether. The aromatic amine-initiated polyether polyols may have primary or secondary hydroxyl end groups. In some implementations, propylene oxide is the primary or essentially sole alkylene oxide used to prepare the aromatic amine-initiated polyether polyol. This means that, in these implementations, propylene oxide is used in an amount of more than 50% by weight or at least 60% by weight, such as 60 to 70% by weight, based on the total weight of alkylene oxide used to prepare the aromatic amine-initiated polyether polyol. In some implementations, ethylene oxide is employed in a relatively small amount. In these implementations, ethylene oxide is used in an amount of no more than 50% by weight, or no more than 40% by weight, such as 30 to 40% by weight, based on the total weight of alkylene oxide used to prepare the aromatic amine-initiated polyether polyol.

In some embodiments, the aromatic amine-initiated polyether polyol has an OH number of 200 to 600 mg KOH/g and a functionality of at least 2.5. In some implementations, the aromatic amine-initiated polyether polyol has an OH number of 300 to 500 mg KOH/g, such as 380 to 420 mg KOH/g and an average functionality of 3.5 to 4.5, 3.8 to 4.2 or 4.0.

In some implementations, the foregoing aromatic amine-initiated polyether polyol is present in an amount of at least 10% by weight, based on the total weight of polyol that is present. More specifically, in some implementations, the foregoing aromatic amine-initiated polyol is present in an amount of 10 to 40% by weight, such as 10 to 30% by weight, or, in some cases, 10 to 25% by weight or 15 to 25% by weight, based on the total weight of the polyol blend.

In some embodiments, the polyol blend also includes a saccharide-initiated polyether polyol. As used herein, “saccharide-initiated polyether polyol” refers to a polyether polyol that is the reaction product of an H-functional starter comprising saccharide, such as sucrose, with alkylene oxide. Examples of suitable alkylene oxides include ethylene oxide, propylene oxide, butylene oxide, styrene oxide, epichlorohydrin, or a mixture of any two or more thereof. Some examples of suitable saccharide initiators are sucrose, sorbitol, maltitol, etc. as well as other mono-saccharides, di-saccharides, tri-saccharides and polysaccharides. Other initiator compounds are often used in combination with the saccharide initiator to prepare the saccharide-initiated polyether polyol. Saccharides can be co-initiated with for example, compounds such as water, propylene glycol, glycerin, ethylene glycol, ethanol amines, diethylene glycol, or a mixture of any two or more thereof. As will be appreciated, it is possible to use a wide variety of individual initiator compounds in combination with saccharide initiator.

In some implementations, saccharide is the predominant H-functional starter used to produce the saccharide-initiated polyether polyol. This means that, in these implementations, saccharide is present in an amount of more than 50% by weight, such as at least 70% by weight or at least 80% by weight, based on the total weight of H-functional starter used to produce the saccharide-initiated polyether polyol.

In some implementations, propylene oxide is the primary or essentially sole alkylene oxide used to prepare the saccharide-initiated polyether polyol. This means that, in these implementations, propylene oxide is used in an amount of more than 50% by weight, such as at least 80% by weight, at least 90% by weight, at least 95% by weight, at least 99% by weight, or 100% by weight, based on the total weight of alkylene oxide used to prepare the saccharide-initiated polyether polyol. In some implementations, ethylene oxide is employed in a relatively small amount. Thus, in these implementations, ethylene oxide is present in an amount of no more than 50% by weight, such as no more than 20% by weight, or, in some cases, no more than 10% by weight, based on the total weight of alkylene oxide used to prepare the saccharide-initiated polyether polyol.

In some implementations, the saccharide-initiated polyether polyol has an OH number of 200 to 600 mg KOH/g, such as 300 to 550 mg KOH/g, 300 to 400 mg KOH/g, or, in some cases, 350 to 400 mg KOH/g, and a functionality of 4 to 6, such as 5 to 6, or 5.5 to 6.

In some embodiments, the saccharide-initiated polyether polyol is present in an amount of at least 10% by weight, based on the total weight of polyol that is present. More specifically, in some implementations, the saccharide-initiated polyol is present in an amount of 10 to 50% by weight, such as 20 to 40% by weight, or, in some cases, 25 to 35% by weight, based on the total weight of the polyol blend.

In some implementations, the polyol blend comprises a triol-initiated polyether polyol. As used herein, “triol-initiated polyether polyol” refers to a polyether polyol prepared by reacting an alkylene oxide with a starter in the presence of a suitable catalyst, in which the starter comprises a triol, such as glycerin, trimethylolpropane, trimethylolethane, 2-methylpropane-1, 2,3-triol, 1,2,6-hexanetriol, or a mixture of any two or more thereof. Examples of suitable alkylene oxides include ethylene oxide, propylene oxide, butylene oxide, styrene oxide, and epichlorohydrin, as well as mixtures of two or more thereof. Other initiators may be used in combination with the triol to prepare the triol-initiated polyether polyol. Triols can be co-initiated with for example, water, propylene glycol, ethylene glycol, ethanol amine, or diethylene glycol, as well as mixtures of any two or more thereof. In some implementations, however, triol, such as glycerin, is the predominant starter used to prepare the triol-initiated polyether polyol. As a result, in some implementation, triol, such as glycerin, is present in an amount of greater than 50% by weight, such as at least 60% by weight, at least 70% by weight, at least 80% by weight, at least 90% by weight, or, in some implementations, at least 98% by weight or 100% by weight, based on the total weight of starter employed.

In some implementations, propylene oxide is the primary or essentially sole alkylene oxide used to prepare the triol-initiated polyether polyol. This means that, in these implementations, propylene oxide is used in an amount of more than 50% by weight, such as at least 80% by weight, at least 90% by weight, at least 95% by weight, at least 99% by weight, or 100% by weight, based on the total weight of alkylene oxide used to prepare the triol-initiated polyether polyol. In some implementations, ethylene oxide is employed in a relatively small amount. Thus, in these implementations, ethylene oxide is present in an amount of no more than 50% by weight, such as no more than 20% by weight, or, in some cases, no more than 10% by weight, based on the total weight of alkylene oxide used to prepare the triol-initiated polyether polyol.

In some embodiments, the triol-initiated polyether polyol has an OH number of 300 to 600 mg KOH/g and a functionality of at least 2.5. In some implementations, the triol-initiated polyether polyol has an OH number of 400 to 500 mg KOH/g, such as 450 to 500 mg KOH/g and a functionality of 2.5 to 3.5, 2.8 to 3.2, or 3.0.

In some embodiments, the triol-initiated polyether polyol is present in an amount of at least 30% by weight, based on the total weight of polyol that is present. More specifically, in some implementations, the triol-initiated polyol is present in an amount of 30 to 70% by weight, such as 40 to 60% by weight, or, in some cases, 45 to 55% by weight, based on the total weight of the polyol blend.

In certain implementations, the saccharide-initiated polyether polyol and the aromatic amine-initiated polyether polyol are present in a weight ratio of at least 1:1, such as 1:1 to 3:1, 1:1 to 2:1 or, in some cases, 1.2:1 to 1.8:1. In certain implementations, the triol-initiated polyether polyol and the aromatic amine-initiated polyether polyol are present in a weight ratio of at least 1:1, such as 1:1 to 5:1, 2:1 to 4:1 or 2.0:1 to 3.0:1. In certain implementations, the triol-initiated polyether polyol and the saccharide-initiated polyether polyol are present in a weight ratio of 1:1, such as 1:1 to 3:1, 1:1 to 2:1 or, in some cases, 1.2:1 to 1.8:1.

If desired, the polyol blend may include additional compounds that contain isocyanate-reactive groups, such as chain extenders and/or crosslinking agents, and higher molecular weight polyether polyols and polyester polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine.

In certain implementations, the polyol blend has a weighted average functionality of 3 to 5, such as 3.5 to 4.5 or 3.8 to 4.2, and/or a weighted average hydroxyl number of 300 to 500 mg KOH/g, such as 350 to 450 mg KOH/g. In certain embodiments, the polyol blend is present in the polyurethane foam-forming composition in an amount of at least 50% by weight, such as 50 to 90% by weight or 60 to 80% by weight, based on the total weight of the polyurethane foam-forming composition except for the weight of the polyisocyanate.

In some implementations, the sum of the amount of the aromatic amine-initiated polyether polyol, the saccharide-initiated polyether polyol, and the triol-initiated polyether polyol is at least 90% by weight, such as at least 95% by weight, at least 98% by weight, or, in some cases, 100% by weight, based on the total weight of the polyol blend.

As indicated, the polyurethane foam-forming compositions of this specification further comprise a physical blowing agent composition. As will be appreciated, the term “physical blowing agent” refers to compounds which are used in a liquid or gaseous form and do not react chemically with the isocyanate, but which are dissolved or emulsified in the input substances used in the polyurethane production and vaporize under the normal reaction conditions. Suitable physical blowing agents include, for example, hydrocarbons, such as cyclopentane, isopentane, n-pentane, butane and propane, halogenated hydrocarbons, and other compounds, such as perfluorinated alkanes, like perfluorhexane, perfluorinated alkenes, such as 1,1,1,2,3,4,5,5,5-nonafluoro-4-(trifluoromethyl)-2-pentene, 1,1,1,3,4,4,5,5,5-nonafluoro-2-(trifluoromethyl)-2-pentene or cis-1,1,1,4,4,4-hexafluoro-2-butene, chlorofluoro alkenes, such as trans-1-chloro-3,3,3-trifluoropropene, and ethers, esters, ketones and/or acetals.

In some implementations, physical blowing agent, such as hydrocarbon blowing agent, is present in an amount of at least 5% by weight, such as 5 to 30% by weight or 5 to 20% by weight or 5 to 15% by weight, based on the total weight of the polyurethane foam-forming composition except for the weight of the polyisocyanate.

The polyurethane foam-forming compositions of this specification also include water, which acts as a carbon dioxide generating chemical blowing agent. Specifically, in some embodiments, water is utilized in an amount of at least 1.0% by weight, such as 1.0 to 5.0% by weight, 1.0 to 4.0% by weight, 1.0 to 3.0% by weight, or 1.0 to 2.0% by weight, based on the total weight of the polyurethane foam-forming composition except for the weight of the polyisocyanate.

In certain implementations, the physical blowing agent composition and the water are present in a relative ratio, by weight, of at least 5:1, such as 5:1 to 50:1, 5:1 to 20:1 or, in some cases, 5:1 to 9:1 or 5:1 to 7:1.

The polyurethane foam-forming compositions of this specification also comprise a catalyst composition. More specifically, the catalyst composition comprises a tertiary amine. Specific examples of suitable tertiary amine catalysts include, for example, trialkylamines and heterocyclic amines. Specific examples of suitable tertiary amines include, without limitation, trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethylisopropanolamine, dimethyloctylamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′-(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl)morpholine, 1-methyl-4-(2-dimethylamino)piperidine, 1,4-diazabicyclo[2.2.2]octane, 1,8-diazabicyclo[5.4.0]undec-7-ene and 1,5-diazabicyclo[4.3.0]-5-nonane, or a combination of any two or more thereof. In some implementations, the tertiary amine comprises a chemically blocked tertiary amine (including any of the tertiary amines mentioned above). The chemical blocking can be effected by the protonation of a tertiary amine with an acid, for example formic acid, acetic acid, 2-ethylhexanoic acid, oleic acid, a phenol, or by boron trichloride.

In some implementations, the tertiary amine is present in an amount of 0.01 to 3.0% by weight or 0.3 to 2.5% by weight, or 1.0 to 2.0% by weight, based on the total weight of the polyurethane foam-forming composition except for the weight of the polyisocyanate. More specifically, in some implementations, the tertiary amine comprises an unblocked tertiary amine and a chemically blocked tertiary amine, such as where the unblocked tertiary amine and the chemically blocked tertiary amine are present in a ratio, by weight, of 1:5 to 5:1, 1:3 to 3:1, 1:2 to 2:1 or 1.1:1 to 1:1.1. In addition, in some 0 implementations, each of the unblocked tertiary amine and the chemically blocked tertiary amine are present in amount of 0.1 to 1% by weight, 0.1 to 0.5% by weight, or 0.3 to 0.5% by weight, based on the total weight of the polyurethane foam-forming composition except for the weight of the polyisocyanate.

The catalyst composition further comprises a metal carboxylate having the structure:

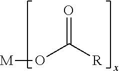

in which each R, which may be the same or different, is a saturated or unsaturated, and optionally substituted with a heteroatom (such as oxygen, nitrogen, sulfur, phosphorous, or a halogen atom, such as fluorine) (cyclo)alkyl group having 2 to 25, such as 5 to 15, 5 to 10 or 7 to 9 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium.

Specific examples of suitable metal carboxylates include metal salts of aliphatic monocarboxylic acids having 2 to 25 carbon atoms. Specific examples of such acids include saturated aliphatic monocarboxylic acids and unsaturated aliphatic monocarboxylic acids, including mixtures thereof. Specific examples of such acids include, without limitation, ethanoic acid, propanoic acid, butanoic acid, pentanoic acid, hexanoic acid, 2-ethylhexanoic acid, heptanoic acid, octanoic acid, nonanoic acid, isononanoic acid, decanoic acid, neodecanoic acid, dodecanoic acid, tetradecanoic acid, hexadecanoic acid, heptadecanoic acid, octadecanoic acid, eicosanoic acid, docosanoic acid, tetracosanoic acid, naphthenic acid, 9-hexadecenoic acid, cis-9-octadecenoic acid, 11-octadecenoic acid, cis, cis-9, 12-octadecadienoic acid, 9,12,15-octadecatrienoic acid, 6,9,12-octadecatrienoic acid, 9,11,13-octadecatrienoic acid, eicosanoic acid, 8,11-eicosadienoic acid, 5,8,11-eicosatrienoic acid, 5,8,11,14-eicosatetraenoic acid, tung oil acid, linseed oil acid, soybean oil acid, resin acid, tall oil fatty acid, rosin acid, abietic acid, neoabietic acid, palustric acid, pimaric acid, dehydroabietic acid, and mixtures of any two or more thereof. In certain specific embodiments, the metal is iron (III), bismuth, zinc, or a combination of any two or more thereof.

In some implementations, the metal carboxylate is present in an amount of 0.01 to 1.0% by weight or 0.02 to 0.5% by weight, or 0.05 to 0.15% by weight, based on the total weight of the polyurethane foam-forming composition except for the weight of the polyisocyanate.

As indicated earlier, the polyurethane foam-forming compositions of this specification comprise a β-dicarbonyl compound. The β-dicarbonyl compound has the structure:

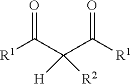

in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹. As used herein, (cyclo)alkyl encompasses linear and branched alkyl and cycloalkyl, such as any linear or branched alkyl and cycloalkyls containing 1 to 25 carbon atoms, and (cyclo)alkoxy encompasses linear and branched alkoxy and cycloalkoxy, such as any linear or branched alkoxy and cycloalkoxys containing 1 to 25 carbon atoms. In some implementations, each R¹, which may be the same or different, is a saturated or unsaturated straight chain, branched, or cyclic alkyl group having 1 to 25 carbon atoms, such as 1 to 10 carbon atoms (such as where each R¹, which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group). In some implementations, R² is hydrogen or a saturated or unsaturated straight chain, branched, or cyclic alkyl group having 1 to 25 carbon atoms, such as 1 to 10 carbon atoms (such as where R², which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group). Specific examples of suitable β-dicarbonyl compounds include, without limitation, 2,4-pentadione, 3-chloro-2,4-pentanedione. 3-ethyl-2,4-pentanedione, 3-butyl-2,4-pentanedione, 3-(1-hydroxyethylidene)-2,4-pentanedione, 3-nitro-2,4-pentanedione, 1,1,1-trifluoro-2,4-pentanedione, 2,4-hexanedione, 5-methyl-2,4-hexanedione, 5,5-dimethyl-2,4-hexanedione, 3-ethyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxyphenyl)-1,3-propanedione, 3-oxobutanamide, methylenediformamide, methyl-3-oxobutanoat, N-(2-methyloxyethyl)-3-oxobutanamide, 1,1,1,5,5,5-hexafluoro-2,4-pentadione, 1,1,1-trifluoro-5,5-dimethyl-2,4-hexanedione, 1,1,1,2,2,3,3-heptafluoro-7,7-dimethyl-4,6-octanedione, 3-methyl-2,4-pentadione, or combinations of any two or more thereof.

In some implementations, the β-dicarbonyl compound and the metal carboxylate are present in the polyurethane foam-forming composition in a relative ratio, by weight, of at least 0.5:1, such as 0.5:1 to 10:1, 1:1 to 10:1, 1:1 to 5:1, or 1:1 to 3:1.

The polyurethane foam-forming composition also typically comprises a surfactant. Suitable surfactants include, for example, organosilicon compounds, such as polysiloxane-polyalkyene-block copolymers, such as a polyether-modified polysiloxane. Other possible surfactants include polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. In some implementations, surfactant is utilized in an amount of 0.2 to 5.0% by weight, such as 1 to 3% by weight, based on the total weight of the polyurethane foam-forming composition except for the weight of the polyisocyanate.

Additional materials which may optionally be included in the foam-forming compositions include pigments, colorants, fillers, antioxidants, flame retardants, and stabilizers. Exemplary flame retardants useful in the foam-forming composition include, but are not limited to, reactive bromine-based compounds known to be used in polyurethane chemistry and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

This specification is also directed to methods for producing rigid polyurethane foams. In such processes, a polyisocyanate is reacted with a polyol, such as the polyol blends described in this specification, at an isocyanate index of 0.9 to 1.5, 1.0 to 1.5, 1.1 to 1.2, or 1.1 to 1.15, in which the reaction takes place in the presence of the catalyst composition, the blowing agent composition, and the β-dicarbonyl compound.

The rigid foams may be prepared by blending all of the polyurethane foam-forming composition components, except for the polyisocyanate, together in a phase stable mixture, and then mixing this mixture in the proper ratio with the polyisocyanate. Alternatively, one or more of the components, such as the surfactant, may be combined with the polyisocyanate prior to mixing it with the polyol blend. Other possible implementations would include adding one or more of the components as a separate stream, together with the polyol blend and polyisocyanate. As used herein, the term phase stable means that the composition does not visibly separate when stored for 7 days at about 70° F. (or 21° C.).

Many foam machines are designed to condition and mix only two components in the proper ratio. For use of these machines, a premix of all the components except the polyisocyanate may be employed. According to the two-component method (component A: polyisocyanate; and component B: isocyanate-reactive composition which typically includes the polyol blend, blowing agent, water, catalyst, β-dicarbonyl compound, and surfactant), the components may be mixed in the proper ratio at a temperature of 5 to 50° C., such as 15 to 35° C., injected or poured into a mold having the temperature controlled to within a range of 20 to 70° C., such as 35 to 60° C. The mixture then expands to fill the cavity with the rigid polyurethane foam. This simplifies the metering and mixing of the reacting components which form the foam-forming mixture but requires that the isocyanate reactive composition be phase stable.

Alternatively, the rigid polyurethane foams may also be prepared by the so-called “quasi prepolymer” method. In this method, a portion of the polyol component is reacted in the absence of the urethane-forming catalysts with the polyisocyanate component in proportion so as to provide 10 percent to 35 percent of free isocyanate groups in the reaction product based on the prepolymer. To prepare foam, the remaining portion of the polyol is added, and the components are allowed to react together in the presence of the blowing agent and other appropriate additives such as the catalysts, and surfactants. Other additives may be added to either the isocyanate prepolymer or remaining polyol or both prior to the mixing of the components, whereby at the end of the reaction, rigid foam is provided.

Furthermore, the rigid foam can be prepared in a batch or continuous process by the one-shot or quasi-prepolymer methods using any well-known foaming apparatus. The rigid foam may be produced in the form of slab stock, moldings, cavity fillings, sprayed foam, frothed foam or laminates with other materials such as hardboard, plasterboard, plastics, paper or metal as facer substrates.

This specification also relates to the use of the rigid foams described herein for thermal insulation. That is, the rigid foams of the present specification may find use as an insulating material in refrigeration apparatuses. These rigid foams can be used, for example, as an intermediate layer in composite elements or for filling hollow spaces of refrigerators, freezers, water heaters, or refrigerated trailers. These foams may also find use in the construction industry or for thermal insulation of long-distance heating pipes and containers.

As such, this specification also provides a composite article comprising rigid foam as disclosed herein sandwiched between one or more facer substrates. In certain implementations, the facer substrate may be plastic (such a polypropylene resin reinforced with continuous bi-directional glass fibers or a fiberglass reinforced polyester copolymer), paper, wood, or metal. For example, in certain implementations, the composite article may be a refrigeration apparatus such as a refrigerator, freezer, or cooler with an exterior metal shell and interior plastic liner. In certain implementations, the refrigeration apparatus may be a trailer, and the composite article may include the foams in sandwich composites for trailer floors or sidewalls.

It was observed, surprisingly, that different metal carboxylate catalysts responded differently to the presence of the β-dicarbonyl compound. In the case of iron octoate, the catalyst exhibited delayed gelation which correlated with increased amount of β-dicarbonyl compound and the flow data demonstrated a dramatic shift in the magnitude and timing of foaming pressure (lower pressure and a later maximum value). The results also suggest a synergistic interaction between the iron octoate catalyst and the amine catalysts with respect to the blowing reaction as observed by the increases/spikes in the rise rates (flow) that were observed roughly around the time that the catalyst would likely be “unblocked”. This overall behavior affords the ability to carefully tune the kinetics of the system to maximize flow performance and foam quality. On the other hand, when evaluating a metal carboxylate catalyst that was based on a bismuth/zinc neodecanoate blend, the impact of the β-dicarbonyl compound was different. While no change in gelation was observed, it was noticed that the presence of the β-dicarbonyl compound resulted in a boost in overall rise rate and also shifted the flow to an earlier, narrower window-which could be an unexpected benefit as more of the foam flow is occurring prior to foam gelation and viscosity build (compared to the control which had a more prolonged flow).

Various aspects of the subject matter described herein are set out in the following numbered clauses:
Clause 1. A polyurethane foam-forming composition comprising: (a) a polyol; (b) a catalyst composition comprising: (i) a tertiary amine, and (ii) a metal carboxylate having the structure:

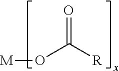

in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium; (c) a blowing agent composition comprising: (i) a physical blowing agent, and (ii) water; (d) a β-dicarbonyl compound having the structure:

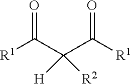

in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹; and (e) a polyisocyanate.
Clause 2. The polyurethane foam-forming composition of clause 1, wherein the polyisocyanate comprises a methylene-bridged polyphenyl polyisocyanate and/or a prepolymer of methylene-bridged polyphenyl polyisocyanate having an average functionality of 1.8 to 3.5, such as from 2.0 to 3.1, isocyanate moieties per molecule, and an NCO content of 25 to 32 weight percent.
Clause 3. The polyurethane foam-forming composition of clause 1 or clause 2, wherein the polyol comprises a polyether polyol, such as a polyol blend comprising two or more different polyether polyols, such as those prepared by addition of an alkylene oxide onto a starter compound having isocyanate-reactive hydrogen atoms, optionally in the presence of a catalyst, such as a base catalyst or a double metal cyanide (DMC) compound.
Clause 4. The polyurethane foam-forming composition of clause 3, wherein the polyol blend comprises an aromatic amine-initiated polyether polyol that is the reaction product of an H-functional starter comprising an aromatic amine, such as TDA (such as o-TDA), with alkylene oxide.
Clause 5. The polyurethane foam-forming composition of clause 4, wherein the aromatic amine is present in an amount of more than 50% by weight, at least 80% by weight, at least 90% by weight, or 100% by weight, based on the total weight of H-functional starter used to produce the aromatic amine-initiated polyether polyol.
Clause 6. The polyurethane foam-forming composition of clause 4 or clause 5, wherein the alkylene oxide used to produce the aromatic amine-initiated polyether polyol comprises ethylene oxide, propylene oxide, butylene oxide, amylene oxide, or a mixture of any two or more thereof, such as where propylene oxide is used in an amount of more than 50% by weight, at least 60% by weight, or 60 to 70% by weight, based on the total weight of alkylene oxide used to prepare the aromatic amine-initiated polyether polyol and ethylene oxide is used in an amount of no more than 50% by weight, no more than 40% by weight, or 30 to 40% by weight, based on the total weight of alkylene oxide used to prepare the aromatic amine-initiated polyether polyol.
Clause 7. The polyurethane foam-forming composition of one of clause 4 to clause 6, wherein the aromatic amine-initiated polyether polyol has an OH number of 200 to 600 mg KOH/g, 300 to 500 mg KOH/g, or 380 to 420 mg KOH/g and a functionality of at least 2.5, 3.5 to 4.5, 3.8 to 4.2 or 4.0.
Clause 8. The polyurethane foam-forming composition of one of clause 4 to clause 7, wherein the aromatic amine-initiated polyether polyol is present in an amount of at least 10% by weight, 10 to 40% by weight, 10 to 30% by weight, 10 to 25% by weight or 15 to 25% by weight, based on the total weight of the polyol blend.
Clause 9. The polyurethane foam-forming composition of one of clause 3 to clause 8, wherein the polyol blend also comprises a saccharide-initiated polyether polyol that is the reaction product of an H-functional starter comprising saccharide, such as sucrose, with alkylene oxide.
Clause 10. The polyurethane foam-forming composition of clause 9, wherein the saccharide is present in an amount of more than 50% by weight, at least 70% by weight, or at least 80% by weight, based on the total weight of H-functional starter used to produce the saccharide-initiated polyether polyol.
Clause 11. The polyurethane foam-forming composition of clause 9 or clause 10,wherein the propylene oxide is used in an amount of more than 50% by weight, at least 80% by weight, at least 90% by weight, at least 95% by weight, at least 99% by weight, or 100% by weight, based on the total weight of alkylene oxide used to prepare the saccharide-initiated polyether polyol and ethylene oxide is present in an amount of no more than 50% by weight, no more than 20% by weight, or no more than 10% by weight, based on the total weight of alkylene oxide used to prepare the saccharide-initiated polyether polyol.
Clause 12. The polyurethane foam-forming composition of one of clause 9 to clause 11, wherein the saccharide-initiated polyether polyol has an OH number of 200 to 600 mg KOH/g, 300 to 550 mg KOH/g, 300 to 400 mg KOH/g, or 350 to 400 mg KOH/g, and a functionality of 4 to 6, 5 to 6, or 5.5 to 6.
Clause 13. The polyurethane foam-forming composition of one of clause 9 to clause 12, wherein the saccharide-initiated polyether polyol is present in an amount of at least 10% by weight, 10 to 50% by weight, 20 to 40% by weight, or 25 to 35% by weight, based on the total weight of the polyol blend.
Clause 14. The polyurethane foam-forming composition of one of clause 3 to clause 13, wherein the polyol blend comprises a triol-initiated polyether polyol that is a reaction product of an alkylene oxide with a starter in the presence of a suitable catalyst, in which the starter comprises a triol, such as glycerin, trimethylolpropane, trimethylolethane, 2-methylpropane-1,2,3-triol, 1,2,6-hexanetriol, or a mixture of any two or more thereof.
Clause 15. The polyurethane foam-forming composition of clause 14, wherein the triol, such as glycerin, is present in an amount of greater than 50% by weight, at least 60% by weight, at least 70% by weight, at least 80% by weight, at least 90% by weight, at least 98% by weight, or 100% by weight, based on the total weight of starter employed to produce the triol-initiated polyether polyol.
Clause 16. The polyurethane foam-forming composition of clause 14 or clause 15, wherein propylene oxide is present in an amount of more than 50% by weight, at least 80% by weight, at least 90% by weight, at least 95% by weight, at least 99% by weight, or 100% by weight, based on the total weight of alkylene oxide used to prepare the triol-initiated polyether polyol and ethylene oxide is present in an amount of no more than 50% by weight, no more than 20% by weight, or no more than 10% by weight, based on the total weight of alkylene oxide used to prepare the triol-initiated polyether polyol.
Clause 17. The polyurethane foam-forming composition of one of clause 14 to clause 16, wherein the triol-initiated polyether polyol has an OH number of 300 to 600 mg KOH/g, 400 to 500 mg KOH/g or 450 to 500 mg KOH/g, a functionality of at least 2.5, 2.5 to 3.5, 2.8 to 3.2, or 3.0, and is present in an amount of at least 30%, 30 to 70% by weight, 40 to 60% by weight, or 45 to 55% by weight, based on the total weight of the polyol blend.
Clause 18. The polyurethane foam-forming composition of one of clause 9 to clause 17, wherein the saccharide-initiated polyether polyol and the aromatic amine-initiated polyether polyol are present in a weight ratio of at least 1:1, 1:1 to 3:1, 1:1 to 2:1 or 1.2 to 1.8:1.
Clause 19. The polyurethane foam-forming composition of one of clause 14 to clause 18, wherein the triol-initiated polyether polyol and the aromatic amine-initiated polyether polyol are present in a weight ratio of at least 1:1, 1:1 to 5:1, 2:1 to 4:1 or 2.0:1 to 3.0:1.
Clause 20. The polyurethane foam-forming composition of one of clause 14 to clause 19, wherein the triol-initiated polyether polyol and the saccharide-initiated polyether polyol are present in a weight ratio of 1:1, 1:1 to 3:1, 1:1 to 2:1 or 1.2 to 1.8:1.
Clause 21. The polyurethane foam-forming composition of one of clause 3 to clause 20, wherein the polyol blend has a weighted average functionality of 3 to 5, 3.5 to 4.5 or 3.8 to 4.2.
Clause 22. The polyurethane foam-forming composition of one of clause 3 to clause 21, wherein the polyol blend has a weighted average hydroxyl number of 300 to 500 mg KOH/g or 350 to 450 mg KOH/g.
Clause 23. The polyurethane foam-forming composition of one of clause 3 to clause 22, wherein the polyol blend is present in the polyurethane foam-forming composition in an amount of at least 50% by weight, 50 to 90% by weight or 80 to 90% by weight, based on the total weight of the polyurethane foam-forming composition except for the weight of the polyisocyanate.
Clause 24. The polyurethane foam-forming composition of one of clause 14 to clause 23, wherein the sum of the amount of the aromatic amine-initiated polyether polyol, the saccharide-initiated polyether polyol, and the triol-initiated polyether polyol is at least 90% by weight, at least 95% by weight, at least 98% by weight, or 100% by weight, based on the total weight of the polyol blend.
Clause 25. The polyurethane foam-forming composition of one of clause 1 to clause 24, wherein the physical blowing agent comprises a hydrocarbon, such as cyclopentane, isopentane, n-pentane, butane and propane, a perfluorinated alkene, such as 1,1,1,2,3,4,5,5,5-nonafluoro-4-(trifluoromethyl)-2-pentene, 1,1,1,3,4,4,5,5,5-nonafluoro-2-(trifluoromethyl)-2-pentene or cis-1,1,1,4,4,4-hexafluoro-2-butene, a chlorofluoro alkene, such as trans-1-chloro-3,3,3-trifluoropropene, or a mixture of any two or more thereof.
Clause 26. The polyurethane foam-forming composition of one of clause 1 to clause 25, wherein the physical blowing agent is present in an amount of at least 5% by weight, 5 to 30% by weight, 5 to 20% by weight, or 5 to 15% by weight, based on the total weight of the polyurethane foam-forming composition except for the weight of the polyisocyanate.
Clause 26. The polyurethane foam-forming composition of one of clause 1 to clause 26, wherein the water is present in an amount of at least 1.0% by weight, 1.0 to 5.0% by weight, 1.0 to 4.0% by weight, 1.0 to 3.0% by weight, or 1.0 to 2.0% by weight, based on the total weight of the polyurethane foam-forming composition except for the weight of the polyisocyanate.
Clause 27. The polyurethane foam-forming composition of one of clause 1 to clause 26, wherein the physical blowing agent composition and the water are present in a relative ratio, by weight, of at least 5:1, 5:1 to 50:1, 5:1 to 20:1, 5:1 to 9:1, or 5:1 to 7:1.
Clause 28. The polyurethane foam-forming composition of one of clause 1 to clause 27, wherein the tertiary amine comprises trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethylisopropanolamine, dimethyloctylamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′-(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl)morpholine, 1-methyl-4-(2-dimethylamino)piperidine, 1,4-diazabicyclo[2.2.2]octane, 1,8-diazabicyclo[5.4.0]undec-7-ene and 1,5-diazabicyclo[4.3.0]-5-nonane, or a combination of any two or more thereof, such as where the tertiary amine comprises an unblocked tertiary amine and a chemically blocked tertiary amine, such as where the unblocked tertiary amine and the chemically blocked tertiary amine are present in a ratio, by weight, of 1:5 to 5:1, 1:3 to 3:1, 1:2 to 2:1 or 1.1:1 to 1:1.1 and/or each of the unblocked tertiary amine and the chemically blocked tertiary amine are present in amount of 0.1 to 1% by weight, 0.1 to 0.5% by weight, or 0.3 to 0.5% by weight, based on the total weight of the polyurethane foam-forming composition except for the weight of the polyisocyanate.
Clause 29. The polyurethane foam-forming composition of one of clause 1 to clause 28, wherein the tertiary amine is present in an amount of 0.01 to 3.0% by weight, 0.3 to 2.5% by weight, or 1.0 to 2.0% by weight, based on the total weight of the polyurethane foam-forming composition except for the weight of the polyisocyanate.
Clause 30. The polyurethane foam-forming composition of one of clause 1 to clause 29, wherein each R, which may be the same or different, has 5 to 15, 5 to 10 or 7 to 9 carbon atoms.
Clause 31. The polyurethane foam-forming composition of one of clause 1 to clause 30, wherein the metal carboxylate comprises a metal salt of an aliphatic monocarboxylic acid having 2 to 25 carbon atoms, such as where the aliphatic monocarboxylic acid comprises a saturated aliphatic monocarboxylic acid, an unsaturated aliphatic monocarboxylic acid, or a mixture thereof, such as where the aliphatic monocarboxylic acid comprises ethanoic acid, propanoic acid, butanoic acid, pentanoic acid, hexanoic acid, 2-ethylhexanoic acid, heptanoic acid, octanoic acid, nonanoic acid, isononanoic acid, decanoic acid, neodecanoic acid, dodecanoic acid, tetradecanoic acid, hexadecanoic acid, heptadecanoic acid, octadecanoic acid, eicosanoic acid, docosanoic acid, tetracosanoic acid, naphthenic acid, 9-hexadecenoic acid, cis-9-octadecenoic acid, 11-octadecenoic acid, cis,cis-9,12-octadecadienoic acid, 9,12,15-octadecatrienoic acid, 6,9,12-octadecatrienoic acid, 9,11,13-octadecatrienoic acid, eicosanoic acid, 8,11-eicosadienoic acid, 5,8,11-eicosatrienoic acid, 5,8,11,14-eicosatetraenoic acid, tung oil acid, linseed oil acid, soybean oil acid, resin acid, tall oil fatty acid, rosin acid, abietic acid, neoabietic acid, palustric acid, pimaric acid, dehydroabietic acid, or a mixture of any two or more thereof.
Clause 32. The polyurethane foam-forming composition of one of clause 1 to clause 31, wherein the metal carboxylate is present in an amount of 0.01 to 1.0% by weight, 0.02 to 0.5% by weight, or 0.05 to 0.15% by weight, based on the total weight of the polyurethane foam-forming composition except for the weight of the polyisocyanate.
Clause 33. The polyurethane foam-forming composition of one of clause 1 to clause 32, wherein each R¹, which may be the same or different, is a saturated or unsaturated straight chain, branched, or cyclic alkyl group having 1 to 10 carbon atoms, such as where each R¹, which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group, and/or R² is a saturated or unsaturated straight chain, branched, or cyclic alkyl group having 1 to 10 carbon atoms, such as where R², which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group.
Clause 34. The polyurethane foam-forming composition of one of clause 1 to clause 33, wherein the β-dicarbonyl compound comprises 2,4-pentadione, 3-chloro-2,4-pentanedione. 3-ethyl-2,4-pentanedione, 3-butyl-2,4-pentanedione, 3-(1-hydroxyethylidene)-2,4-pentanedione, 3-nitro-2,4-pentanedione, 1,1,1-trifluoro-2,4-pentanedione, 2,4-hexanedione, 5-methyl-2,4-hexanedione, 5,5-dimethyl-2,4-hexanedione, 3-ethyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxyphenyl)-1,3-propanedione, 3-oxobutanamide, methylenediformamide, methyl-3-oxobutanoat, N-(2-methyloxyethyl)-3-oxobutanamide, 1,1,1,5,5,5-hexafluoro-2,4-pentadione, 1,1,1-trifluoro-5,5-dimethyl-2,4-hexanedione, 1,1,1,2,2,3,3-heptafluoro-7,7-dimethyl-4,6-octanedione, 3-methyl-2,4-pentadione, or a combination of any two or more thereof.
Clause 35. The polyurethane foam-forming composition of one of clause 1 to clause 34, wherein the β-dicarbonyl compound and the metal carboxylate are present in a relative ratio, by weight, of at least 0.5:1, such as 0.5:1 to 10:1, 1:1 to 10:1, 1:1 to 5:1, or 1:1 to 3:1.
Clause 36. A method of producing a polyurethane foam comprising reacting, at an isocyanate index of 0.90 to 1.50, a polyurethane foam-forming composition comprising: (a) a polyol; (b) a polyisocyanate; (c) a catalyst composition; (d) a blowing agent composition; and (e) a β-dicarbonyl compound, wherein (1) the catalyst composition comprises (i) a tertiary amine, and (ii) a metal carboxylate having the structure:

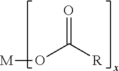

in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium; (2) the blowing agent composition comprises a physical blowing agent and water; and (3) the β-dicarbonyl compound has the structure:

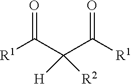

in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹.
Clause 37. The method of clause 36, wherein the isocyanate index is 1.0 to 1.5, 1.1 to 1.2, or 1.1 to 1.15.
Clause 38. The method of clause 36 or clause 37, wherein the polyisocyanate comprises a methylene-bridged polyphenyl polyisocyanate and/or a prepolymer of methylene-bridged polyphenyl polyisocyanate having an average functionality of 1.8 to 3.5, such as 2.0 to 3.1, isocyanate moieties per molecule, and an NCO content of 25 to 32 weight percent.
Clause 39. The method of one of clause 36 to clause 38, wherein the polyol comprises a polyether polyol, such as a polyol blend comprising two or more different polyether polyols, such as those prepared by addition of an alkylene oxide onto a starter compound having isocyanate-reactive hydrogen atoms, optionally in the presence of a catalyst, such as a base catalyst or a double metal cyanide (DMC) compound.
Clause 40. The method of clause 39, wherein the polyol blend comprises an aromatic amine-initiated polyether polyol that is the reaction product of an H-functional starter comprising an aromatic amine, such as TDA (such as o-TDA), with alkylene oxide.
Clause 41. The method of clause 40, wherein the aromatic amine is present in an amount of more than 50% by weight, at least 80% by weight, at least 90% by weight, or 100% by weight, based on the total weight of H-functional starter used to produce the aromatic amine-initiated polyether polyol.
Clause 42. The method of clause 40 or clause 41, wherein the alkylene oxide used to produce the aromatic amine-initiated polyether polyol comprises ethylene oxide, propylene oxide, butylene oxide, amylene oxide, or a mixture of any two or more thereof, such as where propylene oxide is used in an amount of more than 50% by weight, at least 60% by weight, or 60 to 70% by weight, based on the total weight of alkylene oxide used to prepare the aromatic amine-initiated polyether polyol and ethylene oxide is used in an amount of no more than 50% by weight, no more than 40% by weight, or 30 to 40% by weight, based on the total weight of alkylene oxide used to prepare the aromatic amine-initiated polyether polyol.
Clause 43. The method of one of clause 40 to clause 42, wherein the aromatic amine-initiated polyether polyol has an OH number of 200 to 600 mg KOH/g, 300 to 500 mg KOH/g, or 380 to 420 mg KOH/g and a functionality of at least 2.5, 3.5 to 4.5, 3.8 to 4.2 or 4.0.
Clause 44. The method of one of clause 40 to clause 43, wherein the aromatic amine-initiated polyether polyol is present in an amount of at least 10% by weight, 10 to 40% by weight, 10 to 30% by weight, 10 to 255% by weight or 15 to 25% by weight, based on the total weight of the polyol blend.
Clause 45. The method of one of clause 39 to clause 44, wherein the polyol blend also comprises a saccharide-initiated polyether polyol that is the reaction product of an H-functional starter comprising saccharide, such as sucrose, with alkylene oxide.
Clause 46. The method of clause 45, wherein the saccharide is present in an amount of more than 50% by weight, at least 70% by weight, or at least 80% by weight, based on the total weight of H-functional starter used to produce the saccharide-initiated polyether polyol.
Clause 47. The method of clause 45 or clause 46, wherein the propylene oxide is used in an amount of more than 50% by weight, at least 80% by weight, at least 90% by weight, at least 95% by weight, at least 99% by weight, or 100% by weight, based on the total weight of alkylene oxide used to prepare the saccharide-initiated polyether polyol and ethylene oxide is present in an amount of no more than 50% by weight, no more than 20% by weight, or no more than 10% by weight, based on the total weight of alkylene oxide used to prepare the saccharide-initiated polyether polyol.
Clause 48. The method of one of clause 45 to clause 47, wherein the saccharide-initiated polyether polyol has an OH number of 200 to 600 mg KOH/g, 300 to 550 mg KOH/g, 300 to 400 mg KOH/g, or 350 to 400 mg KOH/g, and a functionality of 4 to 6, 5 to 6, or 5.5 to 6.
Clause 49. The method of one of clause 45 to clause 48, wherein the saccharide-initiated polyether polyol is present in an amount of at least 10% by weight, 10 to 50% by weight, 20 to 40% by weight, or 25 to 35% by weight, based on the total weight of the polyol blend.
Clause 50. The method of one of clause 39 to clause 49, wherein the polyol blend comprises a triol-initiated polyether polyol that is a reaction product of an alkylene oxide with a starter in the presence of a suitable catalyst, in which the starter comprises a triol, such as glycerin, trimethylolpropane, trimethylolethane, 2-methylpropane-1, 2,3-triol, 1,2,6-hexanetriol, or a mixture of any two or more thereof.
Clause 51. The method of clause 50, wherein the triol, such as glycerin, is present in an amount of greater than 50% by weight, at least 60% by weight, at least 70% by weight, at least 80% by weight, at least 90% by weight, at least 98% by weight, or 100% by weight, based on the total weight of starter employed to produce the triol-initiated polyether polyol.
Clause 52. The method of clause 50 or clause 51, wherein propylene oxide is present in an amount of more than 50% by weight, at least 80% by weight, at least 90% by weight, at least 95% by weight, at least 99% by weight, or 100% by weight, based on the total weight of alkylene oxide used to prepare the triol-initiated polyether polyol and ethylene oxide is present in an amount of no more than 50% by weight, no more than 20% by weight, or no more than 10% by weight, based on the total weight of alkylene oxide used to prepare the triol-initiated polyether polyol.
Clause 53. The method of one of clause 50 to clause 52, wherein the triol-initiated polyether polyol has an OH number of 300 to 600 mg KOH/g, 400 to 500 mg KOH/g or 450 to 500 mg KOH/g, a functionality of at least 2.5, 2.5 to 3.5, 2.8 to 3.2, or 3.0, and is present in an amount of at least 30%, 30 to 70% by weight, 40 to 60% by weight, or 45 to 55% by weight, based on the total weight of the polyol blend.
Clause 54. The method of one of clause 39 to clause 53, wherein the saccharide-initiated polyether polyol and the aromatic amine-initiated polyether polyol are present in a weight ratio of at least 1:1, 1:1 to 3:1, 1:1 to 2:1 or 1.2 to 1.8:1.
Clause 55. The method of one of clause 50 to clause 54, wherein the triol-initiated polyether polyol and the aromatic amine-initiated polyether polyol are present in a weight ratio of at least 1:1, 1:1 to 5:1, 2:1 to 4:1 or 2.0:1 to 3.0:1.
Clause 56. The method of one of clause 50 to clause 55, wherein the triol-initiated polyether polyol and the saccharide-initiated polyether polyol are present in a weight ratio of 1:1, 1:1 to 3:1, 1:1 to 2:1 or 1.2 to 1.8:1.
Clause 57. The method of one of clause 39 to clause 56, wherein the polyol blend has a weighted average functionality of 3 to 5, 3.5 to 4.5 or 3.8 to 4.2.
Clause 58. The method of one of clause 39 to clause 57, wherein the polyol blend has a weighted average hydroxyl number of 300 to 500 mg KOH/g or 350 to 450 mg KOH/g.
Clause 59. The method of one of clause 39 to clause 58, wherein the polyol blend is present in the polyurethane foam-forming composition in an amount of at least 50% by weight, 50 to 90% by weight or 80 to 90% by weight, based on the total weight of the polyurethane foam-forming composition except for the weight of the polyisocyanate.
Clause 60. The method of one of clause 50 to clause 59, wherein the sum of the amount of the aromatic amine-initiated polyether polyol, the saccharide-initiated polyether polyol, and the triol-initiated polyether polyol is at least 90% by weight, at least 95% by weight, at least 98% by weight, or 100% by weight, based on the total weight of the polyol blend.
Clause 61. The method of one of clause 36 to clause 60, wherein the physical blowing agent comprises a hydrocarbon, such as cyclopentane, isopentane, n-pentane, butane and propane, a perfluorinated alkene, such as 1,1,1,2,3,4,5,5,5-nonafluoro-4-(trifluoromethyl)-2-pentene, 1,1,1,3,4,4,5,5,5-nonafluoro-2-(trifluoromethyl)-2-pentene or cis-1,1,1,4,4,4-hexafluoro-2-butene, a chlorofluoro alkene, such as trans-1-chloro-3,3,3-trifluoropropene, or a mixture of any two or more thereof.
Clause 62. The method of one of clause 36 to clause 61, wherein the physical blowing agent is present in an amount of at least 5% by weight, 5 to 30% by weight, 5 to 20% by weight, or 5 to 15% by weight, based on the total weight of the polyurethane foam-forming composition except for the weight of the polyisocyanate.
Clause 63. The method of one of clause 36 to clause 62, wherein the water is present in an amount of at least 1.0% by weight, 1.0 to 5.0% by weight, 1.0 to 4.0% by weight, 1.0 to 3.0% by weight, or 1.0 to 2.0% by weight, based on the total weight of the polyurethane foam-forming composition except for the weight of the polyisocyanate.
Clause 64. The method of one of clause 36 to clause 63, wherein the physical blowing agent composition and the water are present in a relative ratio, by weight, of at least 5:1, 5:1 to 50:1, 5:1 to 20:1, 5:1 to 9:1, or 5:1 to 7:1.
Clause 65. The method of one of clause 36 to clause 64, wherein the tertiary amine comprises trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethylisopropanolamine, dimethyloctylamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′-(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl)morpholine, 1-methyl-4-(2-dimethylamino)piperidine, 1,4-diazabicyclo[2.2.2]octane, 1,8-diazabicyclo[5.4.0]undec-7-ene and 1,5-diazabicyclo[4.3.0]-5-nonane, or a combination of any two or more thereof, such as where the tertiary amine comprises an unblocked tertiary amine and a chemically blocked tertiary amine, such as where the unblocked tertiary amine and the chemically blocked tertiary amine are present in a ratio, by weight, of 1:5 to 5:1, 1:3 to 3:1, 1:2 to 2:1 or 1.1:1 to 1:1.1 and/or each of the unblocked tertiary amine and the chemically blocked tertiary amine are present in amount of 0.1 to 1% by weight, 0.1 to 0.5% by weight, or 0.3 to 0.5% by weight, based on the total weight of the polyurethane foam-forming composition except for the weight of the polyisocyanate.
Clause 66. The method of one of clause 36 to clause 65, wherein the tertiary amine is present in an amount of 0.01 to 3.0% by weight, 0.3 to 2.5% by weight, or 1.0 to 2.0% by weight, based on the total weight of the polyurethane foam-forming composition except for the weight of the polyisocyanate.
Clause 67. The method of one of clause 36 to clause 66, wherein each R, which may be the same or different, has 5 to 15, 5 to 10 or 7 to 9 carbon atoms.
Clause 68. The method of one of clause 36 to clause 67, wherein the metal carboxylate comprises a metal salt of an aliphatic monocarboxylic acid having 2 to 25 carbon atoms, such as where the aliphatic monocarboxylic acid comprises a saturated aliphatic monocarboxylic acid, an unsaturated aliphatic monocarboxylic acid, or a mixture thereof, such as where the aliphatic monocarboxylic acid comprises ethanoic acid, propanoic acid, butanoic acid, pentanoic acid, hexanoic acid, 2-ethylhexanoic acid, heptanoic acid, octanoic acid, nonanoic acid, isononanoic acid, decanoic acid, neodecanoic acid, dodecanoic acid, tetradecanoic acid, hexadecanoic acid, heptadecanoic acid, octadecanoic acid, eicosanoic acid, docosanoic acid, tetracosanoic acid, naphthenic acid, 9-hexadecenoic acid, cis-9-octadecenoic acid, 11-octadecenoic acid, cis,cis-9,12-octadecadienoic acid, 9,12,15-octadecatrienoic acid, 6,9,12-octadecatrienoic acid, 9,11,13-octadecatrienoic acid, eicosanoic acid, 8,11-eicosadienoic acid, 5,8,11-eicosatrienoic acid, 5,8,11,14-eicosatetraenoic acid, tung oil acid, linseed oil acid, soybean oil acid, resin acid, tall oil fatty acid, rosin acid, abietic acid, neoabietic acid, palustric acid, pimaric acid, dehydroabietic acid, or a mixture of any two or more thereof.
Clause 69. The method of one of clause 36 to clause 68, wherein the metal carboxylate is present in an amount of 0.01 to 1.0% by weight, 0.02 to 0.5% by weight, or 0.05 to 0.15% by weight, based on the total weight of the polyurethane foam-forming composition except for the weight of the polyisocyanate.
Clause 70. The method of one of clause 36 to clause 69, wherein each R¹, which may be the same or different, is a saturated or unsaturated straight chain, branched, or cyclic alkyl group having 1 to 10 carbon atoms, such as where each R¹, which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group, and/or R² is a saturated or unsaturated straight chain, branched, or cyclic alkyl group having 1 to 10 carbon atoms, such as where R², which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group.
Clause 71. The method of one of clause 36 to clause 70, wherein the β-dicarbonyl compound comprises 2,4-pentadione, 3-chloro-2,4-pentanedione. 3-ethyl-2,4-pentanedione, 3-butyl-2,4-pentanedione, 3-(1-hydroxyethylidene)-2,4-pentanedione, 3-nitro-2,4-pentanedione, 1,1,1-trifluoro-2,4-pentanedione, 2,4-hexanedione, 5-methyl-2,4-hexanedione, 5,5-dimethyl-2,4-hexanedione, 3-ethyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxyphenyl)-1,3-propanedione, 3-oxobutanamide, methylenediformamide, methyl-3-oxobutanoat, N-(2-methyloxyethyl)-3-oxobutanamide, 1,1,1,5,5,5-hexafluoro-2,4-pentadione, 1,1,1-trifluoro-5,5-dimethyl-2,4-hexanedione, 1,1,1,2,2,3,3-heptafluoro-7,7-dimethyl-4,6-octanedione, 3-methyl-2,4-pentadione, or a combination of any two or more thereof.
Clause 72. The method of one of clause 36 to clause 71, wherein the β-dicarbonyl compound and the metal carboxylate are present in a relative ratio, by weight, of at least 0.5:1, such as 0.5:1 to 10:1, 1:1 to 10:1, 1:1 to 5:1, or 1:1 to 3:1.
Clause 73. A rigid polyurethane foam formed from the polyurethane foam-forming composition of one of clause 1 to clause 36 or produced by the method of one of clause 36 to clause 72, wherein the rigid polyurethane foam has a closed-cell content of more than 80 percent, more than 85 percent, or more than 88 percent, as measured according to ASTM D6226-15 and/or the rigid polyurethane foam has a thermal conductivity measured at 35° F. (2° C.) of less than 0.126 BTU-in/h-ft²-° F. and measured at 75° F. (24° C.) of less than 0.140 BTU-in/h-ft²-° F. for foam from the core of a 2-inch thick panel, as measured according to ASTM C518-15.
Clause 74. A composite article comprising the rigid polyurethane foam of clause 73 sandwiched between one or more facer substrates, such as where the facer substrates comprise plastic (such a polypropylene resin reinforced with continuous bi-directional glass fibers or a fiberglass reinforced polyester copolymer), paper, wood, or metal.
Clause 75. The composite article of clause 74, wherein the composite article comprises a refrigeration apparatus, such as a refrigerator, freezer, or cooler with an exterior metal shell and interior plastic liner, a trailer floor or sidewall.
Clause 76. An isocyanate-reactive composition comprising: (a) a polyol; (b) a catalyst composition comprising: (i) a tertiary amine, and (ii) a metal carboxylate having the structure:

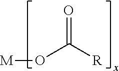

in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), potassium, samarium, sodium, terbium, tin (II), tin (IV), titanium, vanadium, yttrium, zinc, or zirconium; (c) a blowing agent composition comprising (i) a physical blowing agent, and (ii) water; and (d) a β-dicarbonyl compound having the structure:

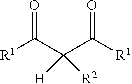

in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom, such as oxygen, nitrogen, sulfur, phosphorous, or a halogen atom, such as fluorine, and may optionally include an amide group, an ester group, or a carboxylic acid group, and (ii) R² is hydrogen or R¹.
Clause 77. The isocyanate-reactive composition of clause 76, wherein the polyol comprises a polyether polyol, such as a polyol blend comprising two or more different polyether polyols, such as those prepared by addition of an alkylene oxide onto a starter compound having isocyanate-reactive hydrogen atoms, optionally in the presence of a catalyst, such as a base catalyst or a double metal cyanide (DMC) compound.
Clause 78. The isocyanate-reactive composition of clause 77, wherein the polyol blend comprises an aromatic amine-initiated polyether polyol that is the reaction product of an H-functional starter comprising an aromatic amine, such as TDA (such as o-TDA), with alkylene oxide.
Clause 79. The isocyanate-reactive composition of clause 78, wherein the aromatic amine is present in an amount of more than 50% by weight, at least 80% by weight, at least 90% by weight, or 100% by weight, based on the total weight of H-functional starter used to produce the aromatic amine-initiated polyether polyol.
Clause 80. The isocyanate-reactive composition of clause 78 or clause 79, wherein the alkylene oxide used to produce the aromatic amine-initiated polyether polyol comprises ethylene oxide, propylene oxide, butylene oxide, amylene oxide, or a mixture of any two or more thereof, such as where propylene oxide is used in an amount of more than 50% by weight, at least 60% by weight, or 60 to 70% by weight, based on the total weight of alkylene oxide used to prepare the aromatic amine-initiated polyether polyol and ethylene oxide is used in an amount of no more than 50% by weight, no more than 40% by weight, or 30 to 40% by weight, based on the total weight of alkylene oxide used to prepare the aromatic amine-initiated polyether polyol.
Clause 81. The isocyanate-reactive composition of one of clause 78 to clause 80, wherein the aromatic amine-initiated polyether polyol has an OH number of 200 to 600 mg KOH/g, 300 to 500 mg KOH/g, or 380 to 420 mg KOH/g and a functionality of at least 2.5, 3.5 to 4.5, 3.8 to 4.2 or 4.0.
Clause 82. The isocyanate-reactive composition of one of clause 78 to clause 81, wherein the aromatic amine-initiated polyether polyol is present in an amount of at least 10% by weight, 10 to 40% by weight, 10 to 30% by weight, 10 to 25% by weight or 15 to 25% by weight, based on the total weight of the polyol blend.
Clause 83. The isocyanate-reactive composition of one of clause 78 to clause 82, wherein the polyol blend also comprises a saccharide-initiated polyether polyol that is the reaction product of an H-functional starter comprising saccharide, such as sucrose, with alkylene oxide.
Clause 84. The isocyanate-reactive composition of clause 83, wherein the saccharide is present in an amount of more than 50% by weight, at least 70% by weight, or at least 80% by weight, based on the total weight of H-functional starter used to produce the saccharide-initiated polyether polyol.
Clause 85. The isocyanate-reactive composition of clause 83 or clause 84, wherein the propylene oxide is used in an amount of more than 50% by weight, at least 80% by weight, at least 90% by weight, at least 95% by weight, at least 99% by weight, or 100% by weight, based on the total weight of alkylene oxide used to prepare the saccharide-initiated polyether polyol and ethylene oxide is present in an amount of no more than 50% by weight, no more than 20% by weight, or no more than 10% by weight, based on the total weight of alkylene oxide used to prepare the saccharide-initiated polyether polyol.
Clause 86. The isocyanate-reactive composition of one of clause 83 to clause 85, wherein the saccharide-initiated polyether polyol has an OH number of 200 to 600 mg KOH/g, 300 to 550 mg KOH/g, 300 to 400 mg KOH/g, or 350 to 400 mg KOH/g, and a functionality of 4 to 6, 5 to 6, or 5.5 to 6.
Clause 87. The isocyanate-reactive composition of one of clause 83 to clause 86, wherein the saccharide-initiated polyether polyol is present in an amount of at least 10% by weight, 10 to 50% by weight, 20 to 40% by weight, or 25 to 35% by weight, based on the total weight of the polyol blend.
Clause 88. The isocyanate-reactive composition of one of clause 77 to clause 87, wherein the polyol blend comprises a triol-initiated polyether polyol that is a reaction product of an alkylene oxide with a starter in the presence of a suitable catalyst, in which the starter comprises a triol, such as glycerin, trimethylolpropane, trimethylolethane, 2-methylpropane-1,2,3-triol, 1,2,6-hexanetriol, or a mixture of any two or more thereof.
Clause 89. The isocyanate-reactive composition of clause 88, wherein the triol, such as glycerin, is present in an amount of greater than 50% by weight, at least 60% by weight, at least 70% by weight, at least 80% by weight, at least 90% by weight, at least 98% by weight, or 100% by weight, based on the total weight of starter employed to produce the triol-initiated polyether polyol.
Clause 90. The isocyanate-reactive composition of clause 88 or clause 89, wherein propylene oxide is present in an amount of more than 50% by weight, at least 80% by weight, at least 90% by weight, at least 95% by weight, at least 99% by weight, or 100% by weight, based on the total weight of alkylene oxide used to prepare the triol-initiated polyether polyol and ethylene oxide is present in an amount of no more than 50% by weight, no more than 20% by weight, or no more than 10% by weight, based on the total weight of alkylene oxide used to prepare the triol-initiated polyether polyol.
Clause 91. The isocyanate-reactive composition of one of clause 88 to clause 90, wherein the triol-initiated polyether polyol has an OH number of 300 to 600 mg KOH/g, 400 to 500 mg KOH/g or 450 to 500 mg KOH/g, a functionality of at least 2.5, 2.5 to 3.5, 2.8 to 3.2, or 3.0, and is present in an amount of at least 30%, 30 to 70% by weight, 40 to 60% by weight, or 45 to 55% by weight, based on the total weight of the polyol blend.
Clause 92. The isocyanate-reactive composition of one of clause 83 to clause 91, wherein the saccharide-initiated polyether polyol and the aromatic amine-initiated polyether polyol in a weight ratio of at least 1:1, 1:1 to 3:1, 1:1 to 2:1 or 1.2 to 1.8:1.
Clause 93. The isocyanate-reactive composition of one of clause 88 to clause 92, wherein the triol-initiated polyether polyol and the aromatic amine-initiated polyether polyol are present in a weight ratio of at least 1:1, 1:1 to 5:1, 2:1 to 4:1 or 2.0:1 to 3.0:1.
Clause 94. The isocyanate-reactive composition of one of clause 88 to clause 93, wherein the triol-initiated polyether polyol and the saccharide-initiated polyether polyol are present in a weight ratio of 1:1, 1:1 to 3:1, 1:1 to 2:1 or 1.2 to 1.8:1.
Clause 95. The isocyanate-reactive composition of one of clause 77 to clause 94, wherein the polyol blend has a weighted average functionality of 3 to 5, 3.5 to 4.5 or 3.8 to 4.2.
Clause 96. The isocyanate-reactive composition of one of clause 77 to clause 95, wherein the polyol blend has a weighted average hydroxyl number of 300 to 500 mg KOH/g or 350 to 450 mg KOH/g.
Clause 97. The isocyanate-reactive composition of one of clause 77 to clause 96, wherein the polyol blend is present in an amount of at least 50% by weight, 50 to 90% by weight or 80 to 90% by weight, based on the total weight of the isocyanate-reactive composition.
Clause 98. The isocyanate-reactive composition of one of clause 88 to clause 97, wherein the sum of the amount of the aromatic amine-initiated polyether polyol, the saccharide-initiated polyether polyol, and the triol-initiated polyether polyol is at least 90% by weight, at least 95% by weight, at least 98% by weight, or 100% by weight, based on the total weight of the polyol blend.
Clause 99. The isocyanate-reactive composition of one of clause 76 to clause 98, wherein the physical blowing agent comprises a hydrocarbon, such as cyclopentane, isopentane, n-pentane, butane and propane, a perfluorinated alkene, such as 1,1,1,2,3,4,5,5,5-nonafluoro-4-(trifluoromethyl)-2-pentene, 1,1,1,3,4,4,5,5,5-nonafluoro-2-(trifluoromethyl)-2-pentene or cis-1,1,1,4,4,4-hexafluoro-2-butene, a chlorofluoro alkene, such as trans-1-chloro-3,3,3-trifluoropropene, or a mixture of any two or more thereof.
Clause 100. The isocyanate-reactive composition of one of clause 76 to clause 99, wherein the physical blowing agent is present in an amount of at least 5% by weight, 5 to 30% by weight, 5 to 20% by weight, or 5 to 15% by weight, based on the total weight of the isocyanate-reactive composition.
Clause 101. The isocyanate-reactive composition of one of clause 76 to clause 100, wherein the water is present in an amount of at least 1.0% by weight, 1.0 to 5.0% by weight, 1.0 to 4.0% by weight, 1.0 to 3.0% by weight, or 1.0 to 2.0% by weight, based on the total weight of the isocyanate-reactive composition.
Clause 102. The isocyanate-reactive composition of one of clause 76 to clause 101, wherein the physical blowing agent composition and the water are present in a relative ratio, by weight, of at least 5:1, 5:1 to 50:1, 5:1 to 20:1, 5:1 to 9:1, or 5:1 to 7:1.
Clause 103. The isocyanate-reactive composition of one of clause 76 to clause 102, wherein the tertiary amine comprises trimethylamine, triethylamine, tripropylamine, tributylamine, dimethylcyclohexylamine, dimethylbenzylamine, dibutylcyclohexylamine, dimethylethanolamine, triethanolamine, diethylethanolamine, ethyldiethanolamine, dimethylisopropanolamine, dimethyloctylamine, triisopropanolamine, triethylenediamine, tetramethyl-1,3-butanediamine, N,N,N′,N′-tetramethylethylenediamine, N,N,N′,N′-tetramethylhexane-1,6-diamine, N,N,N′,N′,N″-pentamethyldiethylenetriamine, bis(2-dimethylaminoethoxy)methane, N,N,N′-trimethyl-N′-(2-hydroxyethyl)ethylenediamine, N,N-dimethyl-N′,N′-(2-hydroxyethyl)ethylenediamine, tetramethylguanidine, N-methylpiperidine, N-ethylpiperidine, N-methylmorpholine, N-ethylmorpholine, 1,4-dimethylpiperidine, 1,2,4-trimethylpiperidine, N-(2-dimethylaminoethyl) morpholine, 1-methyl-4-(2-dimethylamino)piperidine, 1,4-diazabicyclo[2.2.2]octane, 1,8-diazabicyclo[5.4.0]undec-7-ene and 1,5-diazabicyclo[4.3.0]-5-nonane, or a combination of any two or more thereof, such as where the tertiary amine comprises an unblocked tertiary amine and a chemically blocked tertiary amine, such as where the unblocked tertiary amine and the chemically blocked tertiary amine are present in a ratio, by weight, of 1:5 to 5:1, 1:3 to 3:1, 1:2 to 2:1 or 1.1:1 to 1:1.1 and/or each of the unblocked tertiary amine and the chemically blocked tertiary amine are present in amount of 0.1 to 1% by weight, 0.1 to 0.5% by weight, or 0.3 to 0.5% by weight, based on the total weight of the isocyanate-reactive composition.
Clause 104. The isocyanate-reactive composition of one of clause 76 to clause 103, wherein the tertiary amine is present in an amount of 0.01 to 3.0% by weight, 0.3 to 2.5% by weight, or 1.0 to 2.0% by weight, based on the total weight of the isocyanate-reactive composition.
Clause 105. The isocyanate-reactive composition of one of clause 76 to clause 104, wherein each R, which may be the same or different, has 5 to 15, 5 to 10 or 7 to 9 carbon atoms.
Clause 106. The isocyanate-reactive composition of one of clause 76 to clause 105, wherein the metal carboxylate comprises a metal salt of an aliphatic monocarboxylic acid having 2 to 25 carbon atoms, such as where the aliphatic monocarboxylic acid comprises a saturated aliphatic monocarboxylic acid, an unsaturated aliphatic monocarboxylic acid, or a mixture thereof, such as where the aliphatic monocarboxylic acid comprises ethanoic acid, propanoic acid, butanoic acid, pentanoic acid, hexanoic acid, 2-ethylhexanoic acid, heptanoic acid, octanoic acid, nonanoic acid, isononanoic acid, decanoic acid, neodecanoic acid, dodecanoic acid, tetradecanoic acid, hexadecanoic acid, heptadecanoic acid, octadecanoic acid, eicosanoic acid, docosanoic acid, tetracosanoic acid, naphthenic acid, 9-hexadecenoic acid, cis-9-octadecenoic acid, 11-octadecenoic acid, cis,cis-9,12-octadecadienoic acid, 9,12,15-octadecatrienoic acid, 6,9,12-octadecatrienoic acid, 9,11,13-octadecatrienoic acid, eicosanoic acid, 8,11-eicosadienoic acid, 5,8,11-eicosatrienoic acid, 5,8,11,14-eicosatetraenoic acid, tung oil acid, linseed oil acid, soybean oil acid, resin acid, tall oil fatty acid, rosin acid, abietic acid, neoabietic acid, palustric acid, pimaric acid, dehydroabietic acid, or a mixture of any two or more thereof.
Clause 107. The isocyanate-reactive composition of one of clause 76 to clause 106, wherein the metal carboxylate is present in an amount of 0.01 to 1.0% by weight, 0.02 to 0.5% by weight, or 0.05 to 0.15% by weight, based on the total weight of the isocyanate-reactive composition.
Clause 108. The isocyanate-reactive composition of one of clause 76 to clause 107, wherein each R¹, which may be the same or different, is a saturated or unsaturated straight chain, branched, or cyclic alkyl group having 1 to 10 carbon atoms, such as where each R¹, which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group, and/or R² is a saturated or unsaturated straight chain, branched, or cyclic alkyl group having 1 to 10 carbon atoms, such as where R², which may be the same or different, is methyl, ethyl, propyl, isopropyl, butyl, isobutyl, t-butyl, pentyl, hexyl, cyclohexyl, heptyl, octyl, dodecanyl, octadecanyl, vinyl, an allyl, prenyl, crotyl, cyclopentadienyl, phenyl, tolyl, xylyl, or a substituted aryl group.
Clause 109. The isocyanate-reactive composition of one of clause 76 to clause 108, wherein the β-dicarbonyl compound comprises 2,4-pentadione, 3-chloro-2,4-pentanedione. 3-ethyl-2,4-pentanedione, 3-butyl-2,4-pentanedione, 3-(1-hydroxyethylidene)-2,4-pentanedione, 3-nitro-2,4-pentanedione, 1,1,1-trifluoro-2,4-pentanedione, 2,4-hexanedione, 5-methyl-2,4-hexanedione, 5,5-dimethyl-2,4-hexanedione, 3-ethyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxyphenyl)-1,3-propanedione, 3-oxobutanamide, methylenediformamide, methyl-3-oxobutanoat, N-(2-methyloxyethyl)-3-oxobutanamide, 1,1,1,5,5,5-hexafluoro-2,4-pentadione, 1,1,1-trifluoro-5,5-dimethyl-2,4-hexanedione, 1,1,1,2,2,3,3-heptafluoro-7,7-dimethyl-4,6-octanedione, 3-methyl-2,4-pentadione, or a combination of any two or more thereof.
Clause 110. The isocyanate-reactive composition of one of clause 76 to clause 109, wherein the β-dicarbonyl compound and the metal carboxylate are present in a relative ratio, by weight, of at least 0.5:1, such as 0.5:1 to 10:1, 1:1 to 10:1, 1:1 to 5:1, or 1:1 to 3:1.

The non-limiting and non-exhaustive examples that follow are intended to further describe various non-limiting and non-exhaustive implementations without restricting the scope of the implementations described in this specification.

### EXAMPLES

Foam-forming compositions were prepared using the ingredients and amounts (in parts by weight) set forth in Table 1. The following materials were used:
POLYOL 1: a polyether polyol having a hydroxyl number of 470 mg KOH/g and a functionality of 3, prepared by propoxylating glycerin;
POLYOL 2: a polyether polyol having a hydroxyl number of 380 mg KOH/g and a functionality of 5.8, prepared by propoxylating a mixture of sucrose and water (83% by weight sucrose and 17% by weight water);
POLYOL 3: a polyether polyol having a hydroxyl number of 388 mg KOH/g and a functionality of 4, prepared by alkoxylating o-TDA, in which the alkylene oxide is 63% by weight propylene oxide and 37% by weight ethylene oxide;
SURFACTANT: Tegostab® B-8433 from Evonik;
CATALYST 1: Bis(2-dimethylaminoethyl) ether, commercially as Niax™ A-1 from Momentive;
CATALYST 2: Formic acid blocked version of Bis(2-dimethylaminoethyl) ether commercially as Niax™ A-107 from Momentive;
CATALYST 3: Dimethylpiperazine, commercially available as Jeffcat® DMP from Huntsman;
CATALYST 4: Iron octoate, commercially available as Reaxis® C3001 from Reaxis;
CATALYST 5: a blend of bismuth neodecanoate and zinc neodecanoate, commercially available as Reaxis® C708 from Reaxis;
ADDITIVE 1:2,4-pentadione;
BLOWING AGENT: cyclopentane; and
ISOCYANATE: polymeric diphenylmethane diisocyanate (pMDI); NCO weight 31.5%; viscosity 200 mPa·s @ 25° C. (MONDUR® MR from Covestro).

In each case, a master batch was prepared by mixing the polyols, catalysts, surfactant, additive, water and blowing agents in the amounts indicated in Table 1. Foams were prepared by mixing the masterbatch with the Isocyanate in an amount sufficient to provide the isocyanate index listed in Table 1 and pouring the mixture into an 83 ounce paper cup. The cream time, gel time, tack-free time and free rise density (“FRD”) were recorded.

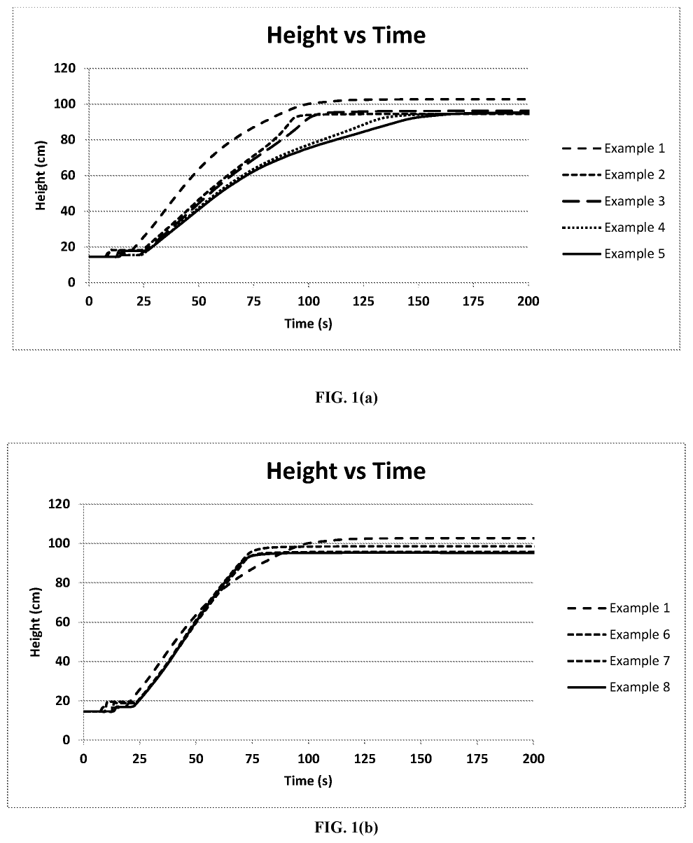

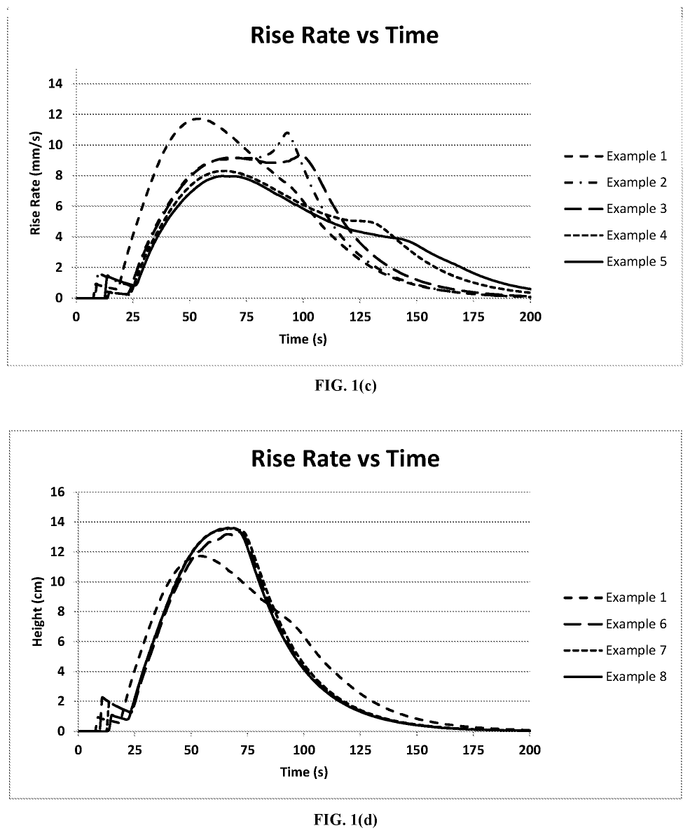

Flow was evaluated as described in U.S. Pat. No. 10,106,641 (at col. 12, lines 22-61, the cited portion of which being incorporated herein by reference). Additionally, a pressure transducer was located 10 cm above the protruding sheet metal-based edge, which recorded the foaming pressure during the process. The rise rate was derived from the foam height data as a function of time. Rise rate profiles for selected examples are displayed in FIGS. 1(a)-1(d). These examples illustrate the ability to tune both the gel and flow behavior based on the incorporation of the iron octoate catalyst and a β-dicarbonyl compound. This flexibility enables the user to optimize foam flow, particularly the balance between flow and gelation, and overall foam performance, which is currently believed to result in improved cell structure and foam performance, leading to improved k-factor, i.e., improved thermal insulation. Furthermore, the incorporation of a bismuth/zinc catalyst and β-dicarbonyl compound affords an improved flow profile with more of the flow occurring prior to gelation and viscosity build.

Results are set forth in Table 1. Examples 3-5 and 7-8 are inventive examples and Examples 1-2 and 6 are comparative examples.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Component | | | | | | | | |
| POLYOL 1 | 42.55 | 43.13 | 43.13 | 43.13 | 43.13 | 43.13 | 43.13 | 43.13 |
| POLYOL 2 | 25.56 | 25.56 | 25.56 | 25.56 | 25.56 | 25.56 | 25.56 | 25.56 |
| POLYOL 3 | 17.18 | 17.18 | 17.18 | 17.18 | 17.18 | 17.18 | 17.18 | 17.18 |
| SURFACTANT | 2.13 | 2.13 | 2.13 | 2.13 | 2.13 | 2.13 | 2.13 | 2.13 |
| CATALYST 1 | 0.43 | 0.43 | 0.43 | 0.43 | 0.43 | 0.43 | 0.43 | 0.43 |
| CATALYST 2 | 0.43 | 0.43 | 0.43 | 0.43 | 0.43 | 0.43 | 0.43 | 0.43 |
| CATALYST 3 | 0.68 | — | — | — | — | — | — | — |
| CATALYST 4 | — | 0.10 | 0.10 | 0.10 | 0.10 | — | — | — |
| CATALYST 5 | — | — | — | — | — | 0.10 | 0.10 | 0.10 |
| ADDITIVE | — | — | 0.10 | 0.25 | 0.50 | — | 0.10 | 0.50 |
| WATER | 1.50 | 1.50 | 1.50 | 1.50 | 1.50 | 1.50 | 1.50 | 1.50 |
| BLOWING AGENT | 9.54 | 9.54 | 9.54 | 9.54 | 9.54 | 9.54 | 9.54 | 9.54 |
| ISOCYANATE INDEX | 1.14 | 1.14 | 1.14 | 1.14 | 1.14 | 1.14 | 1.14 | 1.14 |
| ISOCYANATE RATIO | 1.25 | 1.25 | 1.25 | 1.25 | 1.25 | 1.25 | 1.25 | 1.25 |

RESULTS

| | | | | | | | | |
|---|---|---|---|---|---|---|---|---|
| Cream Time (sec) | 11 | 12 | 16 | 17 | 18 | 10 | 14 | 16 |
| Gel Time (sec) | 91 | 92 | 98 | 127 | 138 | 73 | 73 | 71 |
| Tack Free Time (sec) | 131 | 146 | 148 | 194 | 189 | 114 | 118 | 115 |
| Free-Rise Density (pcf) | 1.69 | 1.78 | 1.70 | 1.81 | 1.68 | 1.74 | 1.76 | 1.76 |
| Flow | | | | | | | | |
| Max Height (cm) | 102.8 | 94.6 | 96.2 | 95.0 | 95.5 | 95.8 | 98.6 | 95.4 |
| Max Pressure (hPa) | 123.9 | 139.6 | 151.1 | 103.9 | 107.2 | 162.4 | 157.1 | 168.0 |
| Max Rise Rate (cm/s) | 11.7 | 10.8 | 9.3 | 8.3 | 8.0 | 13.3 | 13.6 | 13.6 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A polyurethane foam-forming composition comprising:
(a) a polyol;
(b) a catalyst composition comprising:
(i) a tertiary amine, and
(ii) a metal carboxylate having the structure: 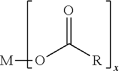
in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), samarium, terbium, tin (II), tin (IV), titanium, vanadium, yttrium, zinc, or zirconium;
(c) a blowing agent composition comprising:
(i) a physical blowing agent, and
(ii) water;
(d) a β-dicarbonyl compound having the structure: 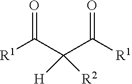
in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom and may optionally include an amide group, an ester group, or a carboxylic acid group, and (ii) R² is hydrogen or R¹; and
(e) a polyisocyanate.

2. The polyurethane foam-forming composition of claim 1, wherein the polyisocyanate comprises a methylene-bridged polyphenyl polyisocyanate and/or a prepolymer of methylene-bridged polyphenyl polyisocyanate having an average functionality of 1.8 to 3.5 isocyanate moieties per molecule, and an NCO content of 25 to 32 weight percent.

3. The polyurethane foam-forming composition of claim 1, wherein the polyol comprises a polyol blend comprising two or more different polyether polyols, wherein the polyol blend comprises an aromatic amine-initiated polyether polyol that is the reaction product of an H-functional starter and an alkylene oxide, wherein the H-functional starter comprises aromatic amine present in an amount of more than 50% by weight, based on the total weight of H-functional starter used to produce the aromatic amine-initiated polyether polyol, propylene oxide is present in an amount of more than 50% by weight, based on the total weight of alkylene oxide used to prepare the aromatic amine-initiated polyether polyol, and wherein the aromatic amine-initiated polyether polyol has an OH number of 200 to 600 mg KOH/g and a functionality of at least 2.5.

4. The polyurethane foam-forming composition of claim 3, wherein the aromatic amine-initiated polyether polyol is present in an amount of 10 to 30% by weight, based on the total weight of the polyol blend.

5. The polyurethane foam-forming composition of claim 4, wherein the polyol blend comprises a saccharide-initiated polyether polyol that is the reaction product of an H-functional starter and an alkylene oxide, wherein the H-functional starter comprises saccharide present in an amount of more than 50% by weight, based on the total weight of H-functional starter used to produce the saccharide-initiated polyether polyol, propylene oxide is present in an amount of more than 50% by weight, based on the total weight of alkylene oxide used to prepare the saccharide-initiated polyether polyol, and wherein the saccharide-initiated polyether polyol has an OH number of 200 to 600 mg KOH/g and a functionality of 4 to 6.

6. The polyurethane foam-forming composition of claim 5, wherein the saccharide-initiated polyether polyol is present in an amount of 20 to 40% by weight, based on the total weight of the polyol blend.

7. The polyurethane foam-forming composition of claim 6, wherein the polyol blend comprises a triol-initiated polyether polyol that is a reaction product of an H-functional starter and an alkylene, wherein the triol is present in an amount of greater than 50% by weight, based on the total weight of H-functional starter used to produce the triol-initiated polyether polyol, propylene oxide is present in an amount of more than 50% by weight, based on the total weight of alkylene oxide used to prepare the triol-initiated polyether polyol, the triol-initiated polyether polyol has an OH number of 300 to 600 mg KOH/g and a functionality of 2.5 to 3.5, and wherein the triol-initiated polyether polyol is present in an amount of 30 to 70% by weight, based on the total weight of the polyol blend.

8. The polyurethane foam-forming composition of claim 1, wherein the physical blowing agent comprises a hydrocarbon that is present in an amount of 5 to 20% by weight, based on the total weight of the polyurethane foam-forming composition except for the weight of the polyisocyanate.

9. The polyurethane foam-forming composition of claim 1, wherein the physical blowing agent composition and the water are present in a relative ratio, by weight, of 5:1 to 9:1.

10. The polyurethane foam-forming composition of claim 1, wherein the tertiary amine comprises an unblocked tertiary amine and a chemically blocked tertiary amine, where the unblocked tertiary amine and the chemically blocked tertiary amine are present in a ratio, by weight, of 1:5 to 5:1.

11. The polyurethane foam-forming composition of claim 1, wherein each R, which may be the same or different, has 5 to 15 carbon atoms.

12. The polyurethane foam-forming composition of claim 1, wherein the metal carboxylate comprises a metal salt of an aliphatic monocarboxylic acid comprising ethanoic acid, propanoic acid, butanoic acid, pentanoic acid, hexanoic acid, 2-ethylhexanoic acid, heptanoic acid, octanoic acid, nonanoic acid, isononanoic acid, decanoic acid, neodecanoic acid, dodecanoic acid, tetradecanoic acid, hexadecanoic acid, heptadecanoic acid, octadecanoic acid, eicosanoic acid, docosanoic acid, tetracosanoic acid, naphthenic acid, 9-hexadecenoic acid, cis-9-octadecenoic acid, 11-octadecenoic acid, cis,cis-9,12-octadecadienoic acid, 9,12,15-octadecatrienoic acid, 6,9,12-octadecatrienoic acid, 9,11,13-octadecatrienoic acid, eicosanoic acid, 8,11-eicosadienoic acid, 5,8,11-eicosatrienoic acid, 5,8,11,14-eicosatetraenoic acid, tung oil acid, linseed oil acid, soybean oil acid, resin acid, tall oil fatty acid, rosin acid, abietic acid, neoabietic acid, palustric acid, pimaric acid, dehydroabietic acid, or a mixture of any two or more thereof.

13. The polyurethane foam-forming composition of claim 1, wherein each R¹, which may be the same or different, is a (cyclo)alkyl group having 1 to 10 carbon atoms.

14. The polyurethane foam-forming composition of claim 13, wherein the β-dicarbonyl compound comprises 2,4-pentadione, 3-chloro-2,4-pentanedione. 3-ethyl-2,4-pentanedione, 3-butyl-2,4-pentanedione, 3-(1-hydroxyethylidene)-2,4-pentanedione, 3-nitro-2,4-pentanedione, 1,1,1-trifluoro-2,4-pentanedione, 2,4-hexanedione, 5-methyl-2,4-hexanedione, 5,5-dimethyl-2,4-hexanedione, 3-ethyl-2,4-pentanedione, 2,4-octanedione, 2,4-decanedione, 2,2-dimethyl-3,5-nonanedione, 2,4-tridecanedione, 1-cyclohexyl-1,3-butanedione, 5,5-dimethyl-1,3-cyclohexanedione, 1,3-cyclohexanedione, 1-phenyl-1,3-butanedione, 1-phenyl-1,3-pentanedione, 1-(4-biphenyl)-1,3-butanedione, 3-benzyl-2,4-pentanedione, 1-phenyl-5,5-dimethyl-2,4-hexanedione, 1-phenyl-2-butyl-1,3-butanedione, and 1-phenyl-3,3-(2-methoxyphenyl)-1,3-propanedione, 3-oxobutanamide, methylenediformamide, methyl-3-oxobutanoat, N-(2-methyloxyethyl)-3-oxobutanamide, 1,1,1,5,5,5-hexafluoro-2,4-pentadione, 1,1,1-trifluoro-5,5-dimethyl-2,4-hexanedione, 1,1,1,2,2,3,3-heptafluoro-7,7-dimethyl-4,6-octanedione, 3-methyl-2,4-pentadione, or a combination of any two or more thereof.

15. The polyurethane foam-forming composition of claim 1, wherein the β-dicarbonyl compound and the metal carboxylate are present in a relative ratio, by weight, of 0.5:1 to 10:1.

16. The polyurethane foam-forming composition of claim 15, wherein the β-dicarbonyl compound and the metal carboxylate are present in a relative ratio, by weight, of 1:1 to 5:1.

17. A method of producing a polyurethane foam comprising reacting, at an isocyanate index of 0.90 to 1.50, a polyurethane foam-forming composition comprising:
(a) a polyol;
(b) a polyisocyanate;
(c) a catalyst composition;
(d) a blowing agent composition; and
(e) a β-dicarbonyl compound, wherein:
(1) the catalyst composition comprises:
(i) a tertiary amine, and
(ii) a metal carboxylate having the structure: 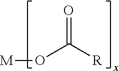
in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), samarium, terbium, tin (II), tin (IV), titanium, vanadium, yttrium, zinc, or zirconium;
(2) the blowing agent composition comprises:
(i) a physical blowing agent, and
(ii) water; and
(3) the β-dicarbonyl compound has the structure: 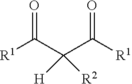
in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom and may optionally include an amide group, an ester group, or a carboxylic acid group, and (ii) R² is hydrogen or R¹.

18. An isocyanate-reactive composition comprising:
(a) a polyol;
(b) a catalyst composition comprising:
(i) a tertiary amine, and
(ii) a metal carboxylate having the structure: 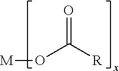
in which each R, which may be the same or different, is a saturated or unsaturated, and optionally substituted, (cyclo)alkyl group having 2 to 25 carbon atoms, x is 2 or 3, and M is aluminum, barium, bismuth, cadmium, calcium, cerium (III), chromium (III), cobalt (II), cobalt (III), copper (II), indium, iron (III), lanthanum, lead (II), manganese (II), manganese (III), neodymium, nickel (II), palladium (II), samarium, terbium, tin (II), tin (IV), titanium, vanadium, yttrium, zinc, or zirconium;
(c) a blowing agent composition comprising:
(i) a physical blowing agent, and
(ii) water; and
(d) a β-dicarbonyl compound having the structure: 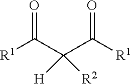
in which: (i) each R¹, which may be the same or different, is an amide group, an ester group, a carboxylic acid group, a (cyclo)alkyl group, or a (cyclo)alkoxy group, wherein the (cyclo)alkyl group and (cyclo)alkoxy group, as the case may be, may optionally be substituted with a heteroatom and may optionally include an amide group, an ester group, or a carboxylic acid group, and (ii) R² is hydrogen or R¹.
